(19) United States
(12) Patent Application Publication
(10) Pub. No.: US 2010/0124639 A1
(43) Pub. Date: May 20, 2010

(54) Process, Compound, Ink and Use

(76) Inventor: Gavin Wright, Manchester (GB)

Correspondence Address: MORGAN LEWIS & BOCKIUS LLP, 1111 PENNSYLVANIA AVENUE NW, WASHINGTON, DC, 20004, US

(21) Appl. No.: 12/598,247

(22) PCT Filed: Apr. 17, 2008
(86) PCT No.: PCT/GB08/01337

§ 371 Date: Oct. 30, 2009

(30) Foreign Application Priority Data
May 3, 2007 (GB) 0708531.9

(51) Int. Cl. C09D 11/02; B05D 5/06; C09B 29/045; B32B 3/10

(52) U.S. Cl. 428/195.1; 106/31.5; 427/256; 534/800

(57) ABSTRACT

A process for printing an image on a substrate comprising applying to the substrate an ink comprising a medium and compound of Formula (1) or a salt thereof:

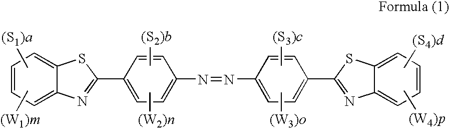

wherein:
each S₁, S₂, S₃ and S₄ independently is a substituent other than a water-dispersing substituent;
each W₁, W₂, W₃ and W₄ independently is a water-dispersing substituent;
a, b, c and d each independently is from 0 to 4;
m, n, o and p each independently is from 0 to 4;
(a+m) has a value of from 0 to 4;
(b+n) has a value of from 0 to 4;
(c+o) has a value of from 0 to 4;
(d+p) has a value of from 0 to 4; and
(n+o) has a value of from 1 to 8.

This invention relates to compounds which are useful as colorants, to inks (especially but not exclusively ink jet printing inks) containing said compounds, to a process for printing said ink on a substrate and to the use of said compounds for preparing ink jet printing inks.

Ink jet printing (hereinafter IJP) is a non-impact printing technique in which droplets of ink are ejected through a fine nozzle onto a substrate without bringing the nozzle into contact with the substrate.

There are many demanding performance requirements for colorants and inks used in IJP. For example, they desirably provide sharp, non-feathered o images having good water-fastness, light-fastness, ozone-fastness and optical density. The inks are often required to dry quickly when applied to a substrate to prevent smudging, but they should not form a crust over the tip of an ink jet nozzle because this will tend to reduce print quality and in extreme cases may prevent the printer from printing. The inks are preferably also stable to storage over time without decomposing or forming a precipitate which could block the fine nozzle. Preferably, the colorants are sufficiently soluble in the ink to provide vivid colours and to allow the preparation of ink concentrates for more economic transportation.

Whilst colorants suitable for ink jet printing such as C.I. Direct Yellow 28 and 29 are known further improvements are still sought especially with regard to solubility, light and ozone-fastness properties.

Polish patents PL135325 and PL130622 disclose benzothiazoyl azo compounds. These two polish patents describe a leather tanning process, no mention of printing or ink jet is made.

U.S. Pat. No. 2,368,657 describes the preparation of p:p′-di(6-methylbenthiazyl)azobenzene disulfonarylamides as dyes for cotton.

According to a first aspect of the present invention there is provided a process for printing an image on a substrate comprising applying to the substrate an ink comprising a medium and compound of Formula (1) or a salt thereof:

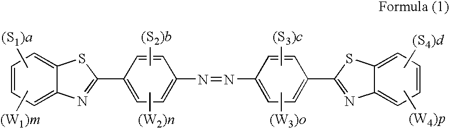

wherein:
each S₁, S₂, S₃ and S₄ independently is a substituent other than a water-dispersing substituent;
each W₁, W₂, W₃ and W₄ independently is a water-dispersing substituent;
a, b, c and d each independently is from 0 to 4;
m, n, o and p each independently is from 0 to 4;
(a+m) has a value of from 0 to 4;
(b+n) has a value of from 0 to 4;
(c+o) has a value of from 0 to 4;
(d+p) has a value of from 0 to 4; and
(n+o) has a value of from 1 to 8.

The water-dispersing substituents represented by W₁, W₂, W₃ and W₄ can be any substituent which tends to promote the dispersibility of the compound of Formula (1) or salt thereof in a liquid medium comprising water. Especially preferred substituents are those which tend to promote dispersibility (especially solubility) of the compound of Formula (1) in water.

Preferably, the water-dispersing substituent is or comprises a non-ionic and/or an ionic group, more preferably the water-dispersing substituent is or comprises an ionic group, more especially the water-dispersing substituent is or comprises an anionic group. Examples of non-ionic water-dispersing groups include hydroxy, polyethyleneoxy, and unsubstituted sulphonamide (—SO₂NH₂) groups.

Preferred examples of anionic water-dispersing groups are phosphato, carboxy and sulfo groups. When written in the form of the free acid these groups are carboxylic acid (—CO₂H), sulfonic acid (—SO₃H) and phosphonic acid (—PO₃H₂).

In one embodiment the water-dispersing substituents may comprise a C₁₋₄ alkyl group and one or more water-dispersing groups, especially those selected from sulfo, phosphato, carboxy, hydroxy and polyethyleneoxy groups.

It is preferred that all of the water-dispersing substituents represented by W₁, W₂, W₃ and W₄ are each independently selected from phosphato, carboxy and sulfo substituents, more preferably all the water-dispersing substituents are each independently selected from carboxy and sulfo substituents. It is especially preferred that all of the water-dispersing substituents are sulfo substituents.

Preferably, none of the groups represented by W₁, W₂, W₃ and W₄ is of the Formula —SO₂—NH-G wherein G represents a substituted aryl (especially phenyl) group which confers water-dispersibility. It is especially preferred that G is not substituted with any thiol groups. Such groups are hydrolytically and oxidatively unstable.

Preferably, none of the groups represented by W₁, W₂, W₃ and W₄ is a cationic group. Preferably, the compound of Formula (1) has no covalently attached cationic groups.

The compound of Formula (1) or salt thereof may have more than one water-dispersing substituent. In this case the water-dispersing substituents may be of different kinds. For example, the compound of Formula (1) or salt thereof may have both sulfo and carboxy substituents. Preferably, however, all the water-dispersing substituents are the same.

Preferably, (n+o) is from 1 to 4, more preferably (n+o) is 2 and especially preferably n=1 and o=1.

Preferably, at least one of the water-dispersing substituents represented collectively by W₂ and W₃ is in an ortho position with respect to the azo group.

More preferably, at least one of the water-dispersing substituents represented by W₂ is in an ortho position with respect to the azo group attached to the phenylene ring and at least one of the water-dispersing substituents represented by W₃ is in an ortho position with respect to the azo group attached to the other phenylene ring.

In one embodiment, (m+p) is from 1 to 4, in this embodiment it is preferred that m=1 and p=1.

Preferably, (m+n+o+p) is from 1 to 4, more preferably from 2 to 4 and especially 2 or 4. This provides compounds having particularly good solubility characteristics, especially for aqueous inks.

The optional substituents represented by S₁, S₂, S₃ and S₄ may be any substituent other than the water-dispersing substituents as mentioned hereinbefore.

Preferred optional substituents include optionally substituted alkyl, alkoxy, amide, ester, ketone and thioether, halo, nitro, cyano, azo and —CF₃ groups.

Preferably, the optionally substituted alkyl group is an optionally substituted C₁₋₈ alkyl group, more preferably an optionally substituted C₁₋₄ alkyl group and especially unsubstituted methyl.

Preferably, the optionally substituted alkoxy group is an optionally substituted C₁₋₈-alkoxy group, more preferably an optionally substituted C₁₋₄-alkoxy group.

Preferably, the optionally substituted amide group is of the formula —(NHC(O)NR¹R², —C(O)NR¹R², —S(O)₂NR¹R² or —NHC(O)R³, wherein R¹, R² and R³ are each independently H or optionally substituted alkyl, aryl or heteroaryl, or R¹ and R² together with the nitrogen atom to which they are attached form an optionally substituted 5- or 6-membered ring (e.g. a piperidine, pyrrolidone, pyridine, piperizine or morpholine ring). In the case of —S(O)₂NR₁R₂ groups R₁ and R₂ are not both H.

Preferred optionally substituted ester groups are of the formula —C(O)OR⁴ or —S(O)₂OR⁴, wherein R⁴ is optionally substituted alkyl, aryl or heteroaryl.

Preferred optionally substituted ketone groups are of the formula —C(O)R⁴ wherein R⁴ is as hereinbefore defined.

Preferred optionally substituted thioether groups are of the formula —SR⁴, wherein R⁴ is as hereinbefore defined.

When any one or more of the groups represented by R¹, R², R³ and R⁴ is o an optionally substituted alkyl group then each group is preferably independently an optionally substituted C₁₋₈, more preferably an optionally substituted C₁₋₄ alkyl group.

When any one or more of the groups represented by R¹, R², R³ and R⁴ is an optionally substituted aryl group then each group is preferably independently an optionally substituted phenyl or naphthyl group, more preferably an optionally substituted phenyl group.

Optionally substituted aryl, heteroaryl, alkyl, alkoxy, amide, ester, ketone or thioether substituents may be substituted with one or more halo, C₁₋₄-alkoxy, cyano and nitro groups.

Preferred halo groups are Cl, F and Br.

Preferably, (a+b+c+d) is from 0 to 4, more preferably from 0 to 2.

It is preferred that (m+n+o+p)>=(a+b+c+d), more preferably (m+n+o+p)−(a+b+c+d) is at least 1, especially at least 2. In this way the water-dispersing groups assist in providing the compound of Formula (1) or salt thereof with overall water-dispersibility (especially water-solubility) even when non-water dispersing substituents are present.

Preferably, (m+n+o+p)−(a+b+c+d) is at most 4, more preferably at most 2. In this way the water-fastness of the compound or salt thereof is improved.

In a preferred embodiment the compound of Formula (1) or salt thereof is of Formula (2) or (3) or salts thereof:

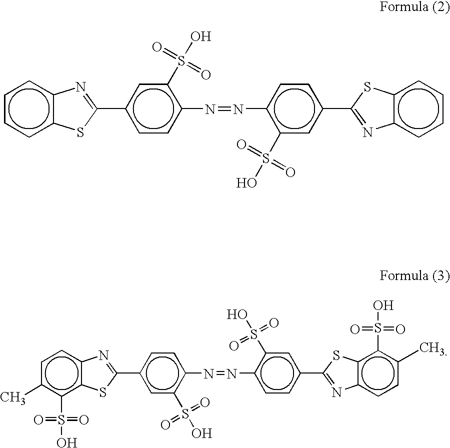

The compounds of Formulae (2) and (3) have particularly high solubility, good ozone and light-fastness and are particularly suited to the requirements for ink jet printing inks.

In a second aspect of the present invention there is provided a compound of Formula (1) or a salt thereof:

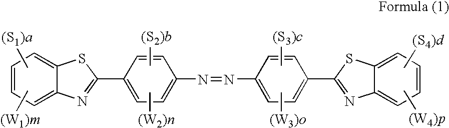

wherein:
S₁, S₂, S₃, S₄, W₁, W₂, W₃, W₄, a, b, c, d, m, n, o and p are as hereinbefore defined, with the proviso that the compound of Formula (1) or a salt thereof is not of Formula (2A), (2B) or a salt thereof:

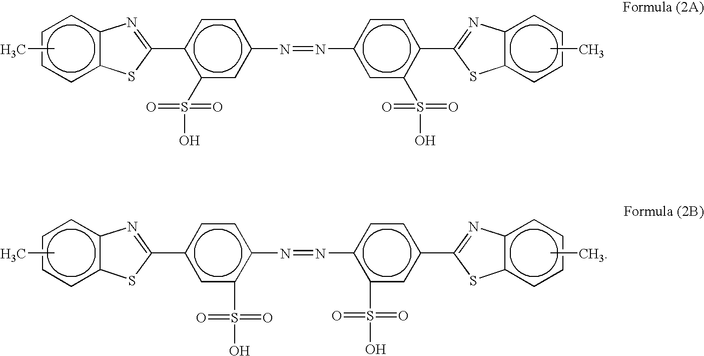

More preferably, in the second aspect of the present invention the compound of Formula (1) is not of Formula (2C) or a salt thereof:

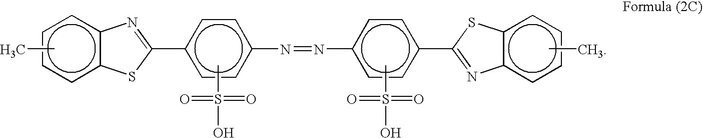

As described above preferably (n+o) is 2, however (n+o) may be other than 2, for example (n+o) is 1, 3 or 4. Other preferences are as described above.

In one embodiment a, d, m and p are each independently 1 or 2. In this embodiment it is preferred that S₁ and S₄ each independently are C₁₋₄ alky groups. In the same embodiment it is also preferred that W₁ and W₂ are sulfo groups. An especially preferred compound according to this embodiment is wherein a, d, m and p all equal 1, S₁ and S₄ are methyl groups and W₁ and W₂ are sulfo groups.

The compounds of Formulae (1) to (3) and salts thereof may exist in tautomeric forms other than those shown in this specification, any such tautomers are included within the scope and claims of the present invention.

Preferred salt forms are water-soluble, for example alkali metal salts (especially lithium, sodium, potassium), ammonium, substituted ammonium and mixed salts thereof.

Preferred ammonium and substituted ammonium salts are ammonium and alkyl or aryl substituted ammonium (e.g. ammonium, alkanolammonium, pyridinium, piperidinium and morpholinium).

It is especially preferred that the compounds of Formula (1) are in the form of a sodium, lithium, potassium or ammonium salt or a mixture thereof.

The salt forms are preferred over the free acid (protonated) forms.

Preferably, the compound of Formula (1) or a salt thereof is a dye, more preferably a dye which is soluble in the liquid medium, especially preferably a water-soluble dye.

The compound of Formula (1) or a salt thereof preferably has a solubility in water of at least 5%, more preferably at least 10% by weight.

Preferably, the compound of Formula (1) or salt thereof is yellow, orange or brown in colour. Preferably, inks containing about 5% by weight of the compound of Formula (1) are yellow in colour.

Many of the compounds of Formula (1) and salts thereof have a bright and vivid yellow shade which is ideally suited to prepare a yellow ink in a trichromatic printing ink set (Cyan, Yellow, Magenta).

Compounds of Formula (1) and salts thereof preferably have no fibre reactive groups because such groups tend to reduce the long-term storage stability of inks. The term fibre reactive group is well understood in the art and is used for example in EP 0356014 A1. Fibre reactive groups are capable, under suitable conditions, of reacting with the hydroxy groups present in cellulosic fibres or with the amino groups present in natural fibres to form a covalent linkage between the fibre and the compound. Examples of fibre reactive groups which are preferably not present in the compounds of Formula (1) include: halo-1,3,5-triazinyl, halo-pyrimidyl, beta-halo-propionyl, beta-halo ethyl-sulphonyl, beta-sulfonic acid ethyl-sulfonyl, beta-halo ethylsulfamyl, chloroacetyl amino, beta-sulfonic acid ethyl sulphamyl and vinyl sulphonyl groups.

Preferably, the compound of Formula (1) or salt thereof contains no additional azo groups other than the one as shown in Formula (1).

Preferably, the compound of Formula (1) contains no thiol groups.

The compounds of Formula (1) or salts thereof can be prepared by reacting a compound of Formula (4) or salt thereof:

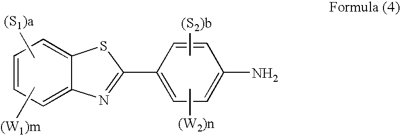

wherein S₁, S₂, W₁, W₂, a, b, m and n are as hereinbefore defined. A preferred reaction is performed using a composition comprising water, a compound of Formula (4) or salt thereof and a permanganate salt at a pH of about 10.

Alternatively, the compound of Formula (4) or a salt thereof may be azo coupled to a compound of Formula (5) or a salt thereof:

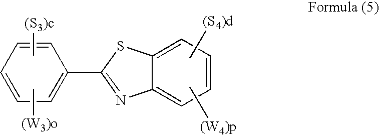

wherein S₃, S₄, W₃, W₄, c, d, o and p are as hereinbefore defined.

For azo coupling the compound of Formula (4) or a salt thereof may be diazotised to give a diazonium salt the resultant diazonium salt can then be coupled with the compound of Formula (5) or a salt thereof.

The diazotisation is preferably performed at a temperature below 20° C., more preferably at a temperature from 0° C. to 5° C. Preferably, the diazotisation is o performed in a liquid comprising water, preferably having a very acidic pH (below 3). Mineral acids (e.g. HCl or H₂SO₄ or mixtures thereof) are typically used to achieve such an acidic pH.

The azo coupling reaction is preferably performed at a temperature of from 0 to 5° C., typically for a period of 1 to 6 hrs. It is often desirable to add a buffer (e.g. sodium acetate) to adjust the pH to 4 to 5. The coupling reaction is preferably performed in a liquid comprising water. The coupling reaction is preferably continued for a further period of 16 hours at a temperature of 25° C.

The compound of Formula (4) or salts thereof can be prepared by reducing a nitro compound of Formula (4a) or a salt thereof:

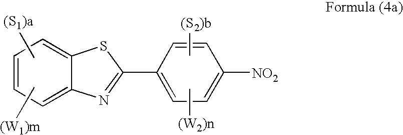

wherein S₁, S₂, W₁, W₂, a, b, n and m are as hereinbefore described.

The compounds of Formulae (4a) and (5) or salts thereof may be prepared by a ring closure reaction starting from compounds of Formulae (4b) and (5a) respectively:

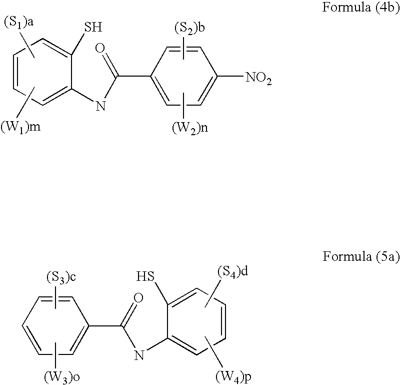

wherein S₁, S₂, S₃, S₄, W₁, W₂, W₃, W₄, a, b, c, d, m, n, o, p are as hereinbefore defined. The ring closure reaction is preferably performed with the compound in an aqueous liquid medium at an acidic pH and at temperatures of 70-100° C.

The compound of Formula (4b) or salts thereof may be prepared by coupling together compounds of Formulae (4c) and (4d) or salts thereof:

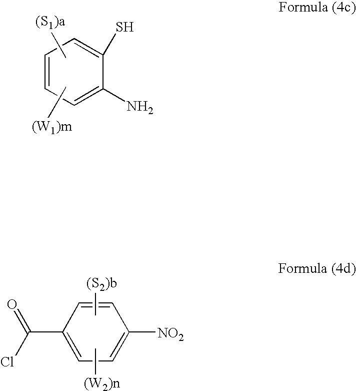

wherein S₁, S₂, W₁, W₂, a, b, m and n are as hereinbefore defined.

The compound of Formula (5a) may be prepared in an analogous manner.

Compounds such as those of Formulae (4c) and (4d) can be prepared by known synthetic techniques such as aromatic electrophilic substitution reactions.

The medium for the ink may be a low melting point solid medium, but is preferably a liquid medium. Preferably, the medium is liquid at a temperature of 25° C.

Preferred liquid media include water, a mixture of water and an organic solvent and an organic solvent free from water.

Preferably, the liquid medium is or comprises water.

When the liquid medium comprises a mixture of water and an organic solvent, the weight ratio of water to organic solvent is preferably from 99:1 to 1:99, more preferably from 99:1 to 50:50 and especially from 95:5 to 70:30.

It is preferred that the organic solvent present in the mixture of water and organic solvent is a water-miscible organic solvent or a mixture of such solvents. Preferred water-miscible organic solvents include C₁₋₆-alkanols, preferably o methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulphoxides, preferably dimethyl sulphoxide and sulpholane. Preferably, the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and di-C₁₋₄-alkyl ethers of diols, more preferably mono-C₁₋₄-alkyl ethers of diols having 2 to 12 carbon atoms, especially 2-methoxy-2-ethoxy-2-ethoxyethanol.

A preferred liquid medium comprises:
(a) from 75 to 95 parts water; and
(b) from 25 to 5 parts in total of one or more organic solvents selected from diethylene glycol, 2-pyrrolidone, thiodiglycol, N-methylpyrrolidone, cyclohexanol, caprolactone, caprolactam and pentane-1,5-diol;
   wherein the parts are by weight and the sum of the parts (a) and (b)=100.

Examples of further suitable ink media comprising a mixture of water and one or more organic solvents are described in U.S. Pat. No. 4,963,189, U.S. Pat. No. 4,703,113, U.S. Pat. No. 4,626,284 and EP 4,251,50A.

When the liquid medium comprises an organic solvent free from water, (i.e. less than 1% water by weight) the organic solvent preferably has a boiling point of from 30° to 200° C., more preferably of from 30° to 150° C., especially from 30 to 125° C. The organic solvent may be water-immiscible, water-miscible or a mixture of such solvents. Preferred water-miscible organic solvents are any of the hereinbefore described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the compound of Formula (1) in the liquid medium. Examples of polar solvents include C₁₋₄-alcohols and ketones.

In view of the foregoing preferences it is especially preferred that when the liquid medium is an organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the medium is an organic solvent free from water it is a mixture of 2 to 5 different organic solvents. This allows a medium to be selected which gives good control over the drying characteristics and storage stability of the ink.

Ink media comprising an organic solvent free from water are particularly useful where fast drying times are required and particularly when printing onto hydrophobic and non-absorbent substrates, for example plastics, metal and glass.

Preferably, the low melting point solid is solid at 25° C. and melts at a temperature above 50° C. More preferably, the low melting point solid has a melting point in the range from 60° C. to 125° C.

Suitable media which melt in this temperature range include long chain fatty acids, sulfonamides and alcohols, preferably those having C₁₈₋₂₄ chains. The compound of Formula (1) may be dissolved in the low melting point solid or may be finely dispersed in it.

The ink may also contain additional components suitable for use in ink jet printing inks, for example viscosity and surface tension modifiers, corrosion inhibitors, biocides, kogation reducing additives and surfactants.

Preferably, the printing is by means of an ink jet printer.

Preferred ink jet printers include thermal and piezo ink jet printers.

The image printed on the substrate may take the form of text, drawings or photographs and the like.

According to a third aspect of the present invention there is provided an ink comprising a compound of Formula (1) or salt thereof according to the second aspect of the present invention and a medium. The medium is as hereinbefore described.

Preferably, the ink according to the third aspect of the present invention comprises:
a) from 0.01 to 30 parts of one or more compounds of the Formula (1) or salts thereof according to the second aspect of the present invention; and
b) from 70 to 99.99 parts of a liquid medium or a low melting point solid medium;
   wherein all parts are by weight and the number of parts of (a)+(b)=100.

The number of parts of component (a) is preferably from 0.1 to 20, more preferably from 0.5 to 15, and especially from 1 to 10 parts. The number of parts of component (b) is preferably from 99.9 to 80, more preferably from 99.5 to 85, especially from 99 to 90 parts.

Preferably, component (a) is completely dissolved in component (b).

Preferably, component (a) has a solubility in component (b) at 20° C. of at least 5%, more preferably at least 10% by weight relative to the total ink. This allows the preparation of concentrates which may be used to prepare more dilute inks and reduces the chance of the compound of Formula (1) or salt thereof precipitating if evaporation of the liquid medium occurs during storage.

The pH of the ink is preferably from 4 to 11, more preferably from 7 to 10.

The viscosity of the ink at 25° C. is preferably less than 50 mPa·s, more preferably less than 20 mPa·s and especially less than 5 mPa·s.

When the ink according to the second aspect of the present invention is used as ink jet printing ink, the ink preferably has a concentration of halide ions of less than 500 parts per million, more preferably less than 100 parts per million. It is especially preferred that the ink has less than 100, more preferably less than 50 parts per million of divalent and trivalent metals. Parts per million as used above refers to parts by weight relative to the total weight of the ink. We have found that purifying the inks to reduce the concentration of these undesirable ions reduces nozzle blockage in ink jet printing heads, particularly in thermal ink jet printers.

When the liquid medium is or comprises water it is preferred that the conductivity of the ink is less than 50 μS/cm, more preferably less than 20 μS/cm, especially less than 10 μS/cm and most especially less than 5 μS/cm. Preferably, the conductivity of the ink is measured when the ink contains 5% by weight in total of compounds of formula (1) or salts thereof according to the second aspect of the present invention. Such a low conductivity helps to prevent kogation of the printer head in thermal ink jet printing. Inks having such a low conductivity can be prepared by for example ultrafiltration.

The compounds of Formula (1) or salts thereof may be used as the sole colorant in the ink because they often have an attractive yellow shade. The ink can comprise two or more compounds of Formula (1) or salts thereof according to the second aspect of the present invention. If desired, one may combine the present compounds or salts thereof with one or more further colorants, for example, if a different shade is required for a particular end use. The further colorants are preferably dyes.

When a yellow shade is required the further colorants are preferably selected from (but not limited to) yellow colorants such as C.I. Direct Yellow 142; is C.I. Direct Yellow 132; C.I. Direct Yellow 86; C.I. Direct Yellow 85; C.I. Direct Yellow 173; and C.I. Acid Yellow 23 and combinations thereof.

The further colorants preferably do not contain any fibre reactive groups.

According to a fourth aspect of the present invention there is provided a substrate printed with an ink according to the third aspect of the present invention.

The substrate is preferably paper, plastic, textile, metal or glass, more preferably paper, an overhead projector slide or a textile material, especially paper.

Preferred papers are plain or treated papers which may have an acid, alkaline or neutral character. Examples of commercially available treated papers include HP Premium Coated Paper, HP Photopaper™ (both available from Hewlett Packard Inc.); Stylus™ Pro 720 dpi Coated Paper, Epson Photo Quality™ Glossy Film, Epson Photo Quality™ Glossy Paper (all available from Seiko Epson Corp.); Canon HR 101 High Resolution™ Paper, Canon GP 201 Glossy™ Paper, Canon HG 101and HG201 High Gloss™ Film, Canon PR101 (all available from Canon); Kodak Premium™ Photopaper, Kodak Premium™ InkJetpaper (available from Kodak); Konica Inkjet Paper QP™ Professional Photo Glossy, Konica Inkjet Paper QP™ Professional Photo 2-sided Glossy, Konica Inkjet Paper QP™ Premium Photo Glossy, Konica Inkjet Paper QP™ Premium Photo Silky (available from Konica). The substrate preferably has an ink jet receptor layer. Ink jet s receptor layers can be porous or swellable.

According to a fifth aspect of the present invention there is provided an ink jet printer cartridge, comprising one or more chambers and an ink wherein the ink is present in at least one of the chambers and the ink is according to the third aspect of the invention.

According to a sixth aspect of the present invention there is provided an ink jet printer comprising one or more ink jet printer cartridge(s) according to the fifth aspect of the present invention.

According to a seventh aspect of the present invention there is provided the use of a compound of Formula (1) or a salt thereof as defined in the first aspect of the present invention for preparing an ink comprising water and said compound or salt thereof, said ink having a conductivity of less than 50 μS/cm, more preferably less than 20 μS/cm, especially less than 10 μS/cm and most especially less than 5 μS/cm. Preferably, the conductivity is measured at 25° C. Preferably, the o conductivity of the ink is measured when the ink contains 5% by weight in total of compounds of formula (1) or salts thereof as defined in the first aspect of the present invention.

The invention is further illustrated by the following Examples in which all parts and percentages are by weight unless otherwise stated.

### EXAMPLES

### Example 1

### Preparation of Dye (1)

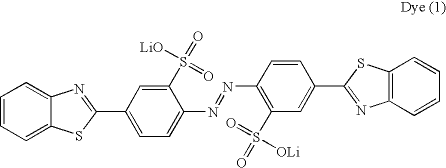

Dye (1) was prepared by stages (a) to (e) as described below:

### Stage (a): Preparation of Intermediate (1a)

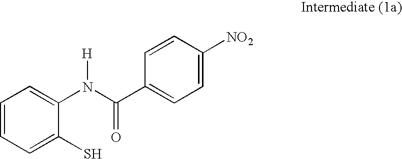

A solution of 4-nitrobenzoyl chloride (66.0 g, 0.39 mol) in acetone (100 ml) was added drop-wise to a solution of 2-aminothiophenol (50.0 g, 0.39 mol) in a mixture of acetone (300 ml) and water (200 ml) at a temperature of from 5 to 10° C., this produced a reaction mixture. The pH of the reaction mixture was maintained at 6 by the addition of 2N sodium hydroxide solution. The reaction mixture was stirred for 1 hour, during this time the product precipitated out and was collected by filtration. The product was washed with a mixture of acetone (100 ml) and water (100 ml). The product was re-crystallised from a mixture of acetone (200 ml) and water (300 ml) and dried to give 69 g (65%) of Intermediate (1a).

### Stage (b): Preparation of Intermediate (1b)

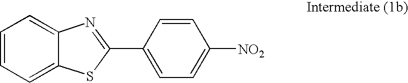

4N hydrochloric acid (300 ml) was added to a solution of Intermediate (1a) from stage (a) (68.5 g, 0.25 mol) in 1-methylpyrrolidinone (300 ml), this produced a reaction mixture. The reaction mixture was stirred at a temperature of 90° C. for a period of 16 hours and then allowed to cool. The product was then precipitated by the addition of water (300 ml) and the resultant solid was collected by filtration and dried to give 38 g (59%) of Intermediate (1b).

### Stage (c): Preparation of Intermediate (1c)

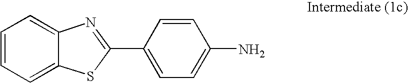

A suspension of iron powder (44 g) in a mixture of water (400 ml) and concentrated hydrochloric acid (5 ml) was stirred at 90° C. for 1 hour, this prepared a reaction mixture. A slurry of Intermediate (1b) from stage (b) (37.1 g, 0.145 mol) in 1-methylpyrrolidinone (150 ml) was added to the reaction mixture in portions over 30 minutes. The reaction mixture was stirred at a temperature of from 90-95° C. for a further 2 hours and then allowed to cool. The pH of the reaction mixture was adjusted to 8 by the addition of Na₂CO₃ and then the reaction mixture was diluted with the addition of methanol (300 ml). The product precipitated out from the reaction mixture. The precipitate was collected by filtration and washed with water (1000 ml) and then with water (2×300 ml). The product was dried to give 29 g (88%) of intermediate (1c).

### Stage (d): Preparation of Intermediate (1d)

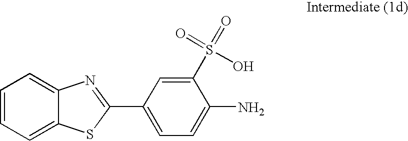

Concentrated sulphuric acid (10 g) was added drop-wise to a solution of Intermediate (1c) from stage (c) (22.6 g, 0.10 mol) in o-dichlorobenzene (200 ml) at a temperature of 20° C. This produced a reaction mixture. The reaction mixture was first stirred at a temperature of 20° C. for 30 minutes and then at reflux o temperature for 16 hours. A Dean and Stark trap was used to collect water during the reaction. The reaction mixture was allowed to cool to 25° C., the product was collected by filtration and washed with acetone (2×300 ml). To remove any unreacted starting materials the product was stirred in 1-methylpyrrolidinone (100 ml) for 30 minutes and the insoluble solid was collected by filtration. The product was then washed with acetone (2×300 ml) and dried to give 30 g (98%) of Intermediate (1d).

### Stage (e): Preparation of Dye (1)

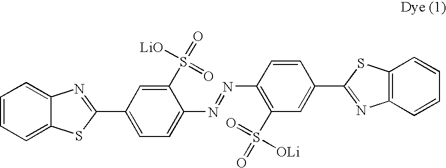

A solution of potassium permanganate (7.0 g, 0.04 mol) in water (100 ml) was added drop-wise to a solution of Intermediate (1d) from stage (d) (15.8 g, 0.04 mol) in water (200 ml) at 40° C. and pH 10 (using 2N NaOH). This produced a reaction mixture. The reaction mixture was stirred at a temperature of 40° C. for a period of 2 hours followed by the addition of acetone (200 ml), the reaction mixture was filtered to remove insoluble material and the filtrate was evaporated under reduced pressure to produce a solid residue. Acetone (300 ml) was added to the solid residue and the product was collected by filtration and washed with acetone (2×300 ml). Concentrated hydrochloric acid was added to a solution of the product in water (250 ml) in order to adjust the pH to 1, acetone (50 ml) was added and the solid which precipitated was collected by filtration. The solid was dissolved in water (300 ml), adjusted to pH 10 (using LiOH) and purified by dialysis in membrane tubing to conductivity of less than 50 μS/cm. After evaporating off the water at 60° C. Dye (1) was obtained (1.6 g, 13%) as an orange solid.

### Example 2

### Preparation of Dye (2)

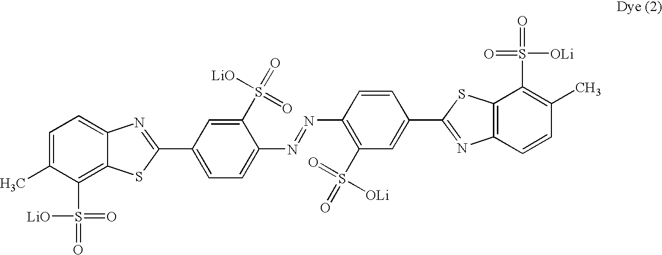

Dye (2) was prepared by the same method as for Dye (1) using stages (d) and (e), except that in stage (d) the product from Example 1 stage (c) was replaced with 2-(4-aminophenyl)-6 methyl-1,3-benzothiazole-7-sulfonic acid (available from Pfaltz and Bauer).

Dyes (1) and (2) may be used to prepare aqueous ink jet printing inks which exhibit particularly good ozone fastness, light fastness have a vivid, bright yellow colour.

### Inks

The inks described in Tables I and II may be prepared wherein the Dye described in the first column is the Dye made in the above Example of the same number. Numbers quoted in the second column onwards refer to the number of parts of the relevant ingredient and all parts are by weight. The inks may be applied to paper by thermal or piezo ink jet printing.

The following abbreviations are used in Table I and II:

PG=propylene glycol

DEG=diethylene glycol

NMP=N-methyl pyrrolidone

DMK=dimethylketone

IPA=isopropanol

MEOH=methanol

2P=2-pyrrolidone

MIBK=methylisobutyl ketone

P12=propane-1,2-diol

BDL=butane-2,3-diol

CET=cetyl ammonium bromide

PHO=Na₂HPO₄ and

TBT=tertiary butanol

TDG=thiodiglycol

TABLE I

| | Dye | | | | | | | Na | | | | |
|---|---|---|---|---|---|---|---|---|---|---|---|---|
| Dye | Content | Water | PG | DEG | NMP | DMK | NaOH | Stearate | IPA | MEOH | 2P | MIBK |
| 1 | 2.0 | 80 | 5 | | 6 | 4 | | | | | 5 | |
| 2 | 3.0 | 90 | | 5 | 5 | | 0.2 | | | | | |
| 1 | 10.0 | 85 | 3 | | 3 | 3 | | | | 5 | 1 | |
| 2 | 2.1 | 91 | | 8 | | | | | | | | 1 |
| 1 | 3.1 | 86 | 5 | | | | | 0.2 | 4 | | | 5 |
| 2 | 1.1 | 81 | | | 9 | | 0.5 | 0.5 | | | 9 | |
| 1 | 2.5 | 60 | 4 | 15 | 3 | 3 | | | 6 | 10 | 5 | 4 |
| 2 | 5 | 65 | | 20 | | | | | 10 | | | |
| 1 | 2.4 | 75 | 5 | 4 | | 5 | | | | 6 | | 5 |
| 2 | 4.1 | 80 | 3 | 5 | 2 | 10 | | 0.3 | | | | |
| 1 | 3.2 | 65 | | 5 | 4 | 6 | | | 5 | 4 | 6 | 5 |
| 2 | 5.1 | 96 | | | | | | | | 4 | | |
| 1 | 10.8 | 90 | 5 | | | | | | 5 | | | |
| 2 | 10.0 | 80 | 2 | 6 | 2 | 5 | | | 1 | | 4 | |
| 1 | 1.8 | 80 | | 5 | | | | | | | 15 | |
| 2 | 2.6 | 84 | | | 11 | | | | | | 5 | |
| 1 | 3.3 | 80 | 2 | | | 10 | | | | 2 | | 6 |
| 2 | 12.0 | 90 | | | | 7 | 0.3 | | 3 | | | |
| 1 | 5.4 | 69 | 2 | 20 | 2 | 1 | | | | | 3 | 3 |
| 2 | 6.0 | 91 | | | 4 | | | | | | 5 | |

TABLE II

| | Dye | | | | | | | | | | | |
|---|---|---|---|---|---|---|---|---|---|---|---|---|
| Dye | Content | Water | PG | DEG | NMP | CET | TBT | TDG | BDL | PHO | 2P | P12 |
| 1 | 3.0 | 80 | 15 | | | 0.2 | | | | | 5 | |
| 2 | 9.0 | 90 | | 5 | | | | | | 1.2 | | 5 |
| 1 | 1.5 | 85 | 5 | 5 | | 0.15 | 5.0 | 0.2 | | | | |
| 2 | 2.5 | 90 | | 6 | 4 | | | | | 0.12 | | |
| 1 | 3.1 | 82 | 4 | 8 | | 0.3 | | | | | | 6 |
| 2 | 0.9 | 85 | | 10 | | | | | 5 | 0.2 | | |
| 1 | 8.0 | 90 | | 5 | 5 | | | 0.3 | | | | |
| 2 | 4.0 | 70 | | 10 | 4 | | | | 1 | | 4 | 11 |
| 1 | 2.2 | 75 | 4 | 10 | 3 | | | | 2 | | 6 | |
| 2 | 10.0 | 91 | | | 6 | | | | | | 3 | |
| 1 | 9.0 | 76 | | 9 | 7 | | 3.0 | | | 0.95 | 5 | |
| 2 | 5.0 | 78 | 5 | 11 | | | | | | | 6 | |
| 1 | 5.4 | 86 | | | 7 | | | | | | 7 | |
| 2 | 2.1 | 70 | 5 | 5 | 5 | 0.1 | 0.2 | 0.1 | 5 | 0.1 | 5 | |
| 1 | 2.0 | 90 | | 10 | | | | | | | | |
| 2 | 2 | 88 | | | | | | 10 | | | | |
| 1 | 5 | 78 | | | 5 | | | 12 | | | 5 | |
| 2 | 8 | 70 | 2 | | 8 | | | 15 | | | 5 | |
| 1 | 10 | 80 | | | | | | 8 | | | 12 | |
| 2 | 10 | 80 | | 10 | | | | | | | | |

1. A process for printing an image on a substrate comprising applying to the substrate an ink comprising a medium and compound of Formula (1) or a salt thereof: 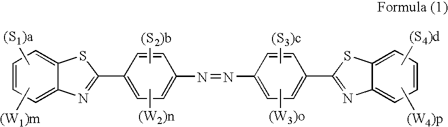
wherein:
each S₁, S₂, S₃ and S₄ independently is a substituent other than a water-dispersing substituent;
each W₁, W₂, W₃ and W₄ independently is a water-dispersing substituent;
a, b, c and d each independently is from 0 to 4;
m, n, o and p each independently is from 0 to 4;
(a+m) has a value of from 0 to 4;
(b+n) has a value of from 0 to 4;
(c+o) has a value of from 0 to 4;
(d+p) has a value of from 0 to 4; and
(n+o) has a value of from 1 to 8.

2. A process according to claim 1 wherein (n+o) is from 1 to 4.

3. A process according to claim 1 wherein at least one of the water-dispersing substituents represented collectively by W₂ and W₃ is in an ortho position with respect to the azo group.

4. A process according to claim 3 wherein at least one of the water-dispersing substituents represented by W₂ is in an ortho position with respect to the azo group attached to the phenylene ring and at least one of the water-dispersing substituents represented by W₃ is in an ortho position with respect to the azo group attached to the other phenylene ring.

5. A process according to claim 1 wherein the compound of Formula (1) or salt thereof is of Formula (2) or (3) or salts thereof:

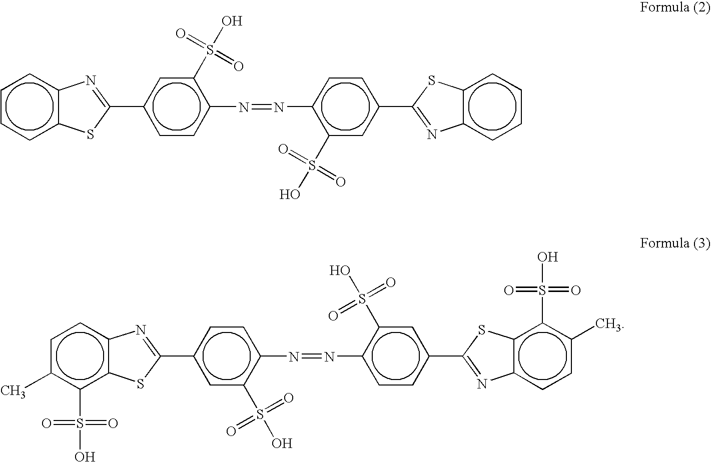

6. A compound of Formula (1) or a salt thereof: 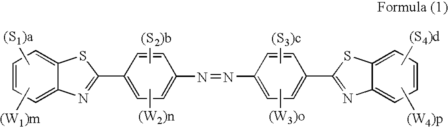
wherein:
each S₁, S₂, S₃ and S₄ independently is a substituent other than a water-dispersing substituent;
each W₁, W₂, W₃ and W₄ independently is a water-dispersing substituent;
a, b, c and d each independently is from 0 to 4;
m, n, o and p each independently is from 0 to 4;
(a+m) has a value of from 0 to 4;
(b+n) has a value of from 0 to 4;
(c+o) has a value of from 0 to 4;
(d+p) has a value of from 0 to 4; and
(n+o) has a value of from 1 to 8;
with the proviso that the compound of Formula (1) or a salt thereof is not of Formula (2A), (2B) or a salt thereof:

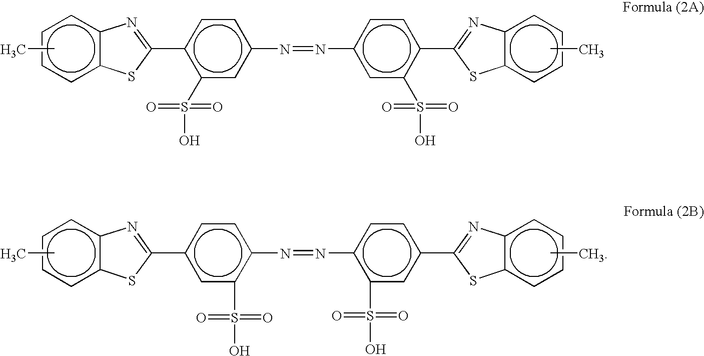

7. A compound or salt thereof according to claim 6 wherein (m+p) is from 1 to 4.

8. A compound of salt thereof according to claim 6 wherein a, d, m and p are each independently 1 or 2.

9. An ink comprising a compound or a salt thereof according to claim 6 and a medium.

10. An ink according to claim wherein the medium a liquid.

11. An ink according to claim 10 wherein the medium is or comprises water and the ink has a conductivity of less than 50 mS/cm.

12. A substrate printed with an ink according to claim 9.

13. An ink jet printer cartridge, comprising one or more chambers and an ink, wherein the ink is present in at least one of the chambers and the ink is according to claim 9.

14. An ink jet printer comprising one or more ink jet printer cartridge(s) according to claim 13.

15. (canceled)
